(19) United States
(12) Patent Application Publication
(10) Pub. No.: US 2006/0248352 A1
(43) Pub. Date: Nov. 2, 2006

(54) Method and system of securing electronic data

(75) Inventors: Thomas H. Adams, San Antonio, TX (US); Yolius Diroo, San Antonio, TX (US); Edward Walter, Boerne, TX (US)

Correspondence Address: BROOKS KUSHMAN P.C., 1000 TOWN CENTER, TWENTY-SECOND FLOOR, SOUTHFIELD, MI, 48075, US

(73) Assignee: SBC Knowledge Ventures, L.P., Reno, NV (US)

(21) Appl. No.: 11/115,925

(22) Filed: Apr. 27, 2005

(51) Int. Cl. G06F 12/14

(52) U.S. Cl. 713/193

(57) ABSTRACT

A method and system of securing electronic data. A protection feature may be included with the data to securing the user thereof. The protection feature may become active upon a triggering event to secure the data.

### BACKGROUND OF THE INVENTION

1. Field of the Invention

The present invention relates to methods and system of securing electronic data.

2. Background Art

Corporations, large and small business, government entities, and individuals may include a file server system and network for accessing electronic data. The electronic data may be stored on a server, database, or other electronic storage medium. Access to the server and/or network may be limit to particular individuals and/or to particular connection points on the network. A login operation or other clearance operation may be performed before users may access the stored data with their computers or hand-held units.

It may be desirable to limit access to the electronic data, such as to prevent the user from disseminating the data without authorization. One particular problem relates to users properly accessing the data through a secured connection and thereafter copying or otherwise transferring the data to a moveable medium, such as a portable computer, disc, CD, or other medium, and/or transferring the data over wireline or wireless connection.

### BRIEF DESCRIPTION OF THE DRAWINGS

FIG. 1 illustrates a system of securing electronic data in accordance with one non-limiting aspect of the present invention; and

FIG. 2 illustrates a method of securing electronic data in accordance with one non-limiting aspect of the present invention.

### DETAILED DESCRIPTION OF THE PREFERRED EMBODIMENT(S)

One non-limiting aspect of the present invention relates to including a data protection feature with transferred data and configuring the data protection feature to become active upon occurrence of a triggering event.

One non-limiting aspect of the present invention relates to securing electronic data, such as to limit access to only employees who are entitled to access the data.

One non-limiting aspect of the present invention relates to securing the electronic data so that the data may be accessed only if a user is authenticated through a secure connection.

One non-limiting aspect of the present invention relates to a method of securing electronic data transferred from an electronic entity to an electronic device. The method may include including an electronic data protection feature with the data when the data is transferred to the electronic device and activating the electronic data protection feature if the electronic device fails to establish a secured connection with the electronic entity.

The method may further include storing the electronic data without the electronic data protection on a server associated with the electronic entity.

The method may further include only inserting the electronic data protection feature if the accessed data is stored on the server as secured data.

The method may further include activating the electronic data protection feature if the electronic device fails to establish a secured connection with the electronic entity and an attempt to access the electronic data is made.

The method may further include destroying the data through a self-destruction operation if the protection feature is activated. Optionally, the method may include issuing a warning prior to destroying the data.

The method may further include requiring entry of a password before permitting access to the data if the protection feature is activated.

The method may further include requiring re-connection of the secured connection before permitting access to the data if the protection feature is activated.

The method may further include including an executable with the protection feature for monitoring establishment of the secured connection.

The method may further include inserting the protection feature within the transferred data.

The method may further include transferring the protection feature for insertion within an operating system of the electronic device, such as for preventing operation of the electronic device if the protection feature is activated.

One non-limiting aspect of the present invention relates to a method of securing electronic data. The electronic data may be associated with an electronic entity and accessible through a secured connection to at least one of a network or a server associated with the electronic entity. The secured connection may be associated with the electronic entity. The method may include transferring electronic data from the electronic entity to an electronic device, and including a self-executing protection feature with the transferred data. The self-executing protection feature may become active upon occurrence of a triggering event to secure the transferred data.

The method may further include activating the self-executing protection feature if the secured connection is inactive.

The method may further include automatically destroying the transferred data upon activation of the protection feature.

The method may further include preventing operation of the electronic device upon activation of the protection feature.

One non-limiting aspect of the present invention relates to a system of securing electronic data. The system may include a server for storing the electronic data and an electronic data protection feature. The electronic data protection feature may be associated with the electronic data and configured to become active upon occurrence of a triggering event to secure the data.

The server may include the electronic data protection feature with data transferred therefrom to an electronic device. The data may be stored on the server without the data protection feature. The triggering event may be based at least in part on the absence of secured connection between an electronic device and the server.

The above features and advantages, along with other features and advantages of the present invention, are readily apparent from the following detailed description of the invention when taken in connection with the accompanying drawings.

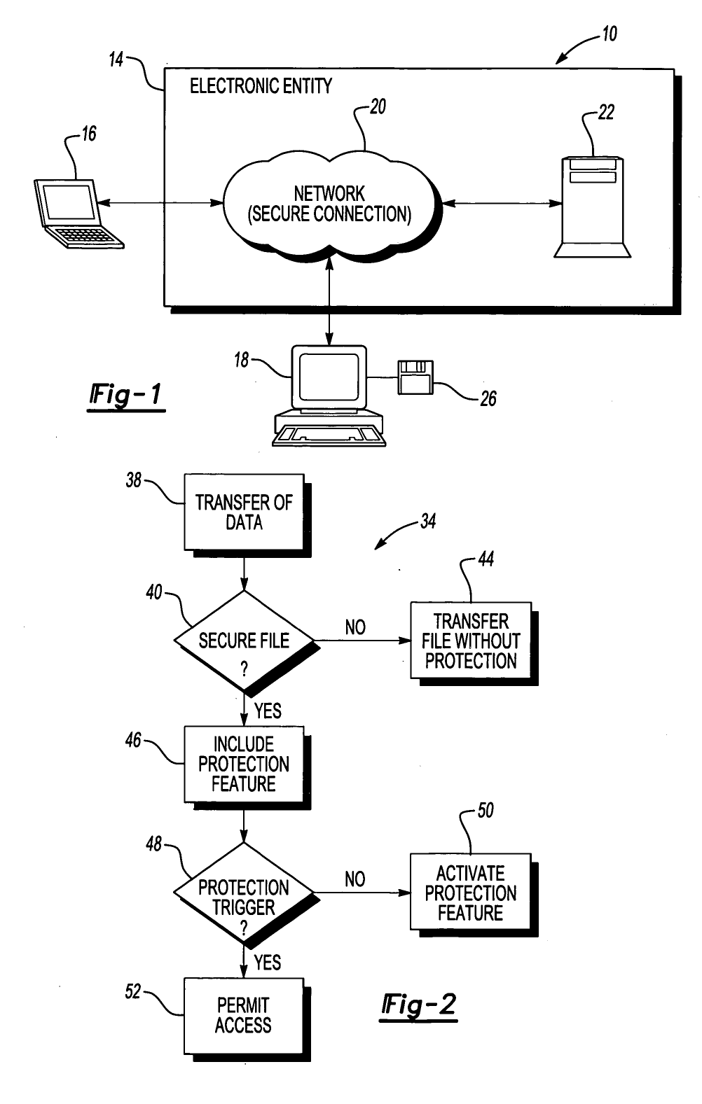

FIG. 1 illustrates a system 10 of securing electronic data in accordance with one non-limiting aspect of the present invention. The system 10 generally relates to an environment where an electronic entity 14 stores electronic data for access by one or more electronic devices 16-18. The electronic entity 14 may be a company, business, individual, and/or other unit.

The electronic entity 14 may include at least one of a network (public or private) 20 and a server or other electronic storage medium 22. The network 20 may provide a communication avenue for the electronic devices 16-18 to communicate with the server 22, such as to facilitate data transfer from the server 22 to the electronic devices 16-18. The network 20 may include wireline or wireless, terrestrial or extraterrestrial, infrastructure. The network 20 may be a standalone network and/or integrated with other networks, such as the Internet.

The electronic devices 16-18 may include computers (desktops and laptops), hand-held units, personal data assistants (PDAs), and other devices having capabilities for accessing data from the server 22, including cellular phones. The present invention contemplates any number of features and configurations for the electronic devices 16-18 and the electronic entity 14 and is not intended to be limited to the foregoing.

The users may be required to establish a secured connection with the network 20 and/or the server 22 in order to obtain access to the electronic data. The secured connection may be established through a login operation or other authorization process. This may include, for example, providing a graphical user interface on the electronic devices 16-18 and requiring the users to input information thereto. Of course, other login processes may be used, including processes which require no user interaction or user inputting of information.

The network 20 may be a private network which requires a secured connection in order to gain access thereto. Once secured access to the network 20 is granted, the user may then have access to the electronic data stored on the server 22 under the presumption that the secured network connection authorizes such access. This may eliminate the need to establish a secure connection directly with the server 22.

Optionally, a secure connection may be established directly with the server 22 through a similar process. The secured connection with the server 22 may be used to provide additional security beyond merely requiring secured access to the network 20 and/or it may used in place thereof, such as to support secured connections to the server 22 when the server 22 is accessed through a public network, i.e., a network which doesn't have a secured connection to the electronic devices 16-18.

The present invention contemplates any number of configurations and features for determining and creating the secured connection with the electronic entity 14, regardless of whether the secured connection occurs between the network 20 and the electronic devices 16-18 and/or between the server 22 and the electronic devices 16-18. The secured connection is intended to cover any interaction between the electronic entity 14 and the electronic devices 16-18 through which access to the electronic data can be at least partially controlled by the electronic entity 14 or system operations associated therewith, i.e., the electronic entity 14 has some security control over the access thereto.

The access to the electronic data may include access associated with copying, retrieving, viewing, reading, and performing other operations associated with transporting the data from the sever 22 to one or more of the electronic devices 16-18. For example, one of the electronic devices 16-18 may desire access to the server 22 in order to view an electronic file and/or to transfer the data to a disc 26. Even if the user desires to only view the file, some form or electronic data is transferred from the server 22 to the device 18.

The system 10 shown in FIG. 1 is shown for merely exemplary purposes and to illustrate an application where users may access electronic data through a secured connection. It is not intended to limit the scope and contemplation of the present invention. The present invention fully contemplates systems, environments, applications and the like which include more or less of these features. Moreover, the present invention in not intended to be limited to corporate, government, or other large entity environments.

FIG. 2 illustrates a flowchart 34 of a method of securing electronic data in accordance with one non-limiting aspect of the present invention. The method is intended to cover securing any type of electronic data, regardless of whether the electronic data is grouped as files or other logical entities and regardless of the content of the electronic data.

Block 38 relates to transferring data from the electronic entity 14 to one or more of the electronic devices 16-18. The transfer may take place between the server 22 and one or more the electronic devices 16-18. The transfer may require a secured connection between the electronic entity 14 and one or more of the electronic devices 16-18, such as through one of the above-identified secured connections.

Block 40 relates to determining whether the transferred data includes a designation or other indicator that it is to be secured or unsecured. The data may be designated as secured or unsecured data according to any number of parameters, which may be determined by a system operation associated with the server 22. The present invention fully contemplates assigning secured and unsecured status to the electronic data as a function of any number of procedures and operations and the selection thereof is not intended to limit the scope and contemplation of the present invention.

Block 44 relates to transferring the data in its stored state, i.e. for example, without any additional protection, if the transferred data is designated as being unsecured. This may include any number of operations and procedures. The data transfer may be performed according to any number of protocols supported by any number of applications, the use of which is not intended to limited the scope and contemplation of the present invention.

Block 46 relates to including a protection feature with the secured data before transferring it from the server 22 to the electronic devices 16-18. The protection feature may be a trigger-based application which becomes active upon occurrence of a particular event, as described below in more detail. Upon activation, the protection feature may protect the data, such as by requiring entry of a password to access or use the data, automatically destructing the data in a self-destruct operation, and/or by requiring establishment of a secured connection between the electronic device and the electronic entity before further use of the data is permitted.

For example, if the transferred data relates to one or more files or other logical grouping, the protection feature may be embedded on or otherwise attached to the files such that it may be carried with the file after being transferred from the server. Thereafter, the protection feature may become active upon occurrence of the triggering event to protect the file. Likewise, the protection feature may a standalone executable which may be transferred with the electronic data to the electronic device. The executable may be configured to insert itself within the operating system of the electronic device to protect the file.

Block 48 relates to determining whether a triggering event has occurred to activate the protection feature. For example, the presence of the secured connection between the electronic devices 16-18 having the data and the electronic entity 14 from which the data was transferred may be used as the triggering event for activating the protection feature. Likewise, time-based triggers and monitoring-based triggers may used to trigger activation of the protection feature.

One example relates to determining the presence of the secured connection when the user attempts to copy, transport, save, read, print, display, or perform other operations which require access to the data. This may include operations which occur after the electronic data is saved to the electronic devices 16-18 and the electronic device(s) 14-18 are subsequently disconnected from the secured connection, such as when the user saves the data to their laptop or other portable device (hand-held) and/or media (CD, thumb-driver, etc.) and subsequently takes the portable unit to an off-site and attempts the access the data thereafter.

One example relates to determining the presence of the secured connection when a user views a file on the electronic device without actually copying the data to a hard-drive or other permanent memory location on the device. The protection feature may include the executable monitoring the presence of the secured connection between the electronic device and the electronic entity, such as while the user is viewing the file. If the user subsequently disconnects from the secured connection, the executable may trigger activation of the protection feature.

Block 50 relates to activating the electronic data protection feature in response to determining the triggering event. For example, the password protection feature may become active such that the user must enter a password if further access to the data is desired. Alternatively, the self-destruct feature may become active such that the data is automatically destroyed. A warning or other feature may be included with the self-destruct protection feature to warn the user prior to destroying the data, such as by implementing time period in which the device must obtain the secured connection before the data is destroy or a warning that asks is the user would like to continue their current attempt to access the data.

Block 52 relates to permitting access to the data if no triggering event is determined. This may include preventing activation of the protection feature so as to permit the user to access the data without further restrictions. Optionally, block 48 may be returned to do continue monitoring the occurrence of a triggering event.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of securing electronic data transferred from an electronic entity to an electronic device, the method comprising:
including an electronic data protection feature with the data when the data is transferred to the electronic device; and
activating the electronic data protection feature if the electronic device fails to establish a secured connection with the electronic entity.

2. The method of claim 1 further comprising:
storing the electronic data without the electronic data protection on a server associated with the electronic entity.

3. The method of claim 2 further comprising:
only inserting the electronic data protection feature if the accessed data is stored on the server as secured data.

4. The method of claim 1 further comprising:
activating the electronic data protection feature if the electronic device fails to establish a secured connection with the electronic entity and an attempt to access the electronic data is made.

5. The method of claim 1 further comprising:
destroying the data through a self-destruction operation if the protection feature is activated.

6. The method of claim 5 further comprising:
issuing a warning prior to destroying the data.

7. The method of claim 1 further comprising:
requiring entry of a password before permitting access to the data if the protection feature is activated.

8. The method of claim 1 further comprising:
requiring re-connection of the secured connection before permitting access to the data if the protection feature is activated.

9. The method of claim 1 further comprising:
including an executable with the protection feature for monitoring establishment of the secured connection.

10. The method of claim 1 further comprising:
inserting the protection feature within the transferred data.

11. The method of claim 1 further comprising:
transferring the protection feature for insertion within an operating system of the electronic device.

12. The method of claim 11 further comprising:
preventing operation of the electronic device if the protection feature is activated.

13. A method of securing electronic data, the electronic data being associated with an electronic entity and accessible through a secured connection to at least one of a network or a server associated with the electronic entity, the secured connection being associated with the electronic entity, the method comprising:
transferring electronic data from the electronic entity to an electronic device; and
including a self-executing protection feature with the transferred data, the self-executing protection feature becoming active upon occurrence of a triggering event to secure the transferred data.

14. The method of claim 13 further comprising:
activating the self-executing protection feature if the secured connection is inactive.

15. The method of claim 13 further comprising:
automatically destroying the transferred data upon activation of the protection feature.

16. The method of claim 13 further comprising:
preventing operation of the electronic device upon activation of the protection feature.

17. A system of securing electronic data, the system comprising:
a server for storing the electronic data; and
an electronic data protection feature, the electronic data protection feature being associated with the electronic data, the electronic data protection feature becoming active upon occurrence of a triggering event to secure the data.

18. The system of claim 17 wherein the server includes the electronic data protection feature with data transferred therefrom to an electronic device.

19. The system of claim 17 wherein the data is stored on the server without the data protection feature.

20. The system of claim 17 wherein the triggering event is based at least in part on the absence of secured connection between an electronic device and the server.
